(19) United States
(12) Patent Application Publication
(10) Pub. No.: US 2006/0007898 A1
(43) Pub. Date: Jan. 12, 2006

(54) Method and apparatus to provide data packet

(76) Inventors: Alexander A. Maltsev, Nizhny Novgorod (RU); Ali S. Sadri, San Diego, CA (US); Vadim S. Sergeyev, Nizhny Novgorod (RU)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/743,309

(22) Filed: Dec. 23, 2003

(51) Int. Cl. H04Q 7/24

(52) U.S. Cl. 370/338

(57) ABSTRACT

Briefly, a wireless communication system that may transmit and/or receive a data packet that may be generated by at least one of the wireless communication devices operated within the wireless communication system. The data packet may include at least one of a compatibility preamble field, a prefix training field, a physical layer convergence protocol header, a data field, a bit power load field and a postfix training field. At least some of the data packet fields may be encoded with a predetermined code and may be modulated by a predetermined modulation scheme.

### BACKGROUND OF THE INVENTION

In wireless local area networks (WLAN), for example, WLAN systems based on IEEE-802.11-1999 standard, wideband (WB) Orthogonal Frequency Division Multiplexing (OFDM) modulation schemes or duplex time division multiplexing (TDM) modulation schemes may be used. In those systems the data rate and throughput of the WLAN may be increased by increasing a spectrum bandwidth of the transmitted signals or by using several OFDM channels in parallel. The WLAN may include stations that may transmit data packets over a non-stationary frequency-selective shared wireless medium, conventionally referred to in the wireless art as a channel.

For example, in some WLAN systems, transmission of data packets may be performed by the stations in-doors. Under these conditions, the signal propagation may include multipath and non-stationary characteristics. The multipath characteristics may be caused by multiple scatters such as walls, ceilings, furniture and other objects in the indoor space, and may result in frequency selectivity of a channel transfer function. Non-stationary characteristics may be caused by motion of scattering objects resulting in a Doppler shift of a received signal frequency. In addition, non-stationary characteristics may be caused by unpredictable behavior of interferences in a band of the received signal. These factors may result in greater Packet Error Rate (PER) and may reduce the throughput performance of wireless network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention;

FIG. 2 is a block diagram of a station according to an exemplary embodiment of the present invention;

FIG. 3 is a schematic illustration of a packet structure according to an exemplary embodiment of the present invention; and

FIG. 4 is a schematic illustration of an exemplary time frequency diagram of a transmitted packet over an OFDM channel according to some embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components, and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as, for example, “processing,” “computing,” “calculating,” “determining,” “establishing” , “sending”, “exchanging” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage medium that may store instructions to perform actions and/or process, if desired.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

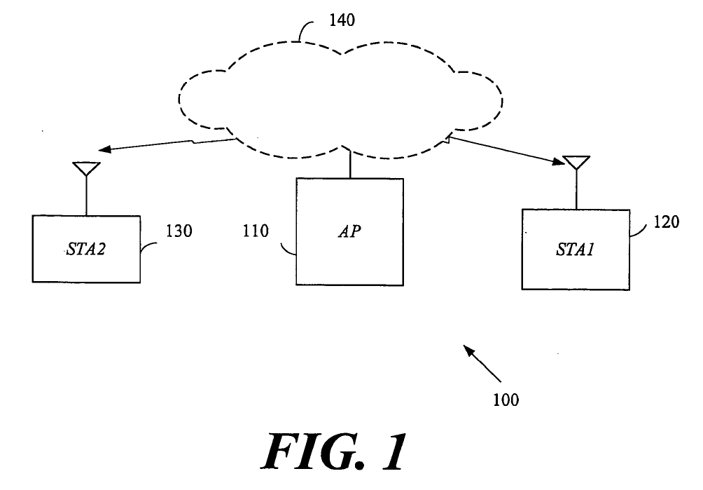

Turning first to FIG. 1, a wireless communication system 100, for example, a WLAN communication system is shown. Although the scope of the present invention is not limited in this respect, the exemplary WLAN communication system 100 may be defined, for example, by the IEEE 802.11-1999 standard, as a basic service set (BSS). For example, BSS may include at least one communication station, for example, an access point (AP) 110, a station 120 (STA1) and a station 130 (STA2). In some embodiments, station 120 and station 130 may transmit and/or receive one or more data packets over a communication channel 140 of wireless communication system 100. The packets may include data, control messages, network information, and the like.

Although the scope of the present invention is not limited in this respect, in some embodiments of the present invention wireless communication system may operate under IEEE 802.11a and/or IEEE 802.11g standard and may transmit and/or receive OFDM signals, if desired. In some embodiments of the inventions, station 120 may communicate with AP 110 via a link 125 and station 130 may communicate with AP 110 via a link 135. In those embodiments, links 125 and 135 may transport OFDM signals, if desired.

Although-the embodiments of the present invention are not limited in this respect, the OFDM signals may include data packets of OFDM symbols. One OFDM symbol may consist of orthogonal subcarriers that may be modulated with portions of data of the data packet in accordance with different modulation schemes. Thus, with some embodiments of the invention, the OFDM data packet may be described as a sequence of OFDM symbols. In some embodiments of the invention, the OFDM data packet may be fragmented into one or more fragments, wherein a fragment may include at least one OFDM symbol. The fragments of the OFDM data packet may be separated, for example, by middle-fix training fields, if desired.

Turning to FIG. 2, a block diagram of a station 200 according to some exemplary embodiments of the present invention is shown. Although the scope of the present invention is not limited in this respect, station 200 may include an antenna 210, a data packet generator 220, an encoder 230 a modulator 240 a transmitter (TX) 250 to transmit radio frequency (RF) signals, a receiver 260 and a predictor 270.

Although the scope of the present invention is not limited in this respect, antenna 210 may be an omni-directional antenna, a monopole antenna, a dipole antenna, an end fed antenna, a circularly polarized antenna, a micro-strip antenna, a diversity antenna, an internal antenna, or the like.

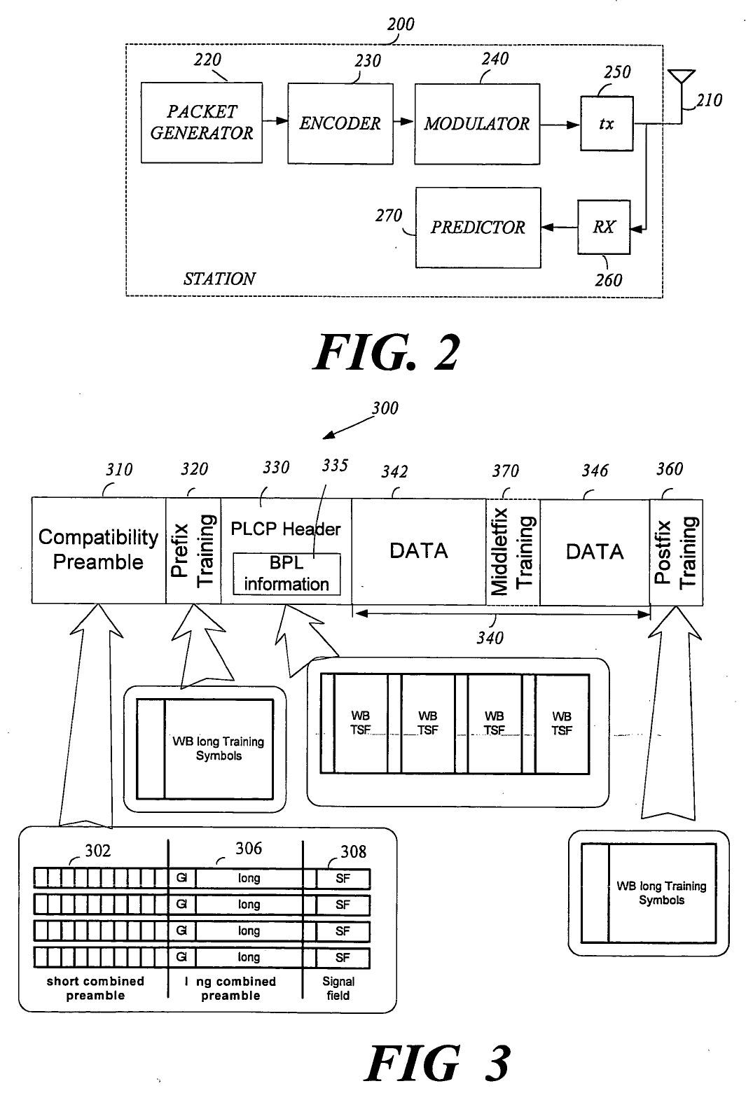

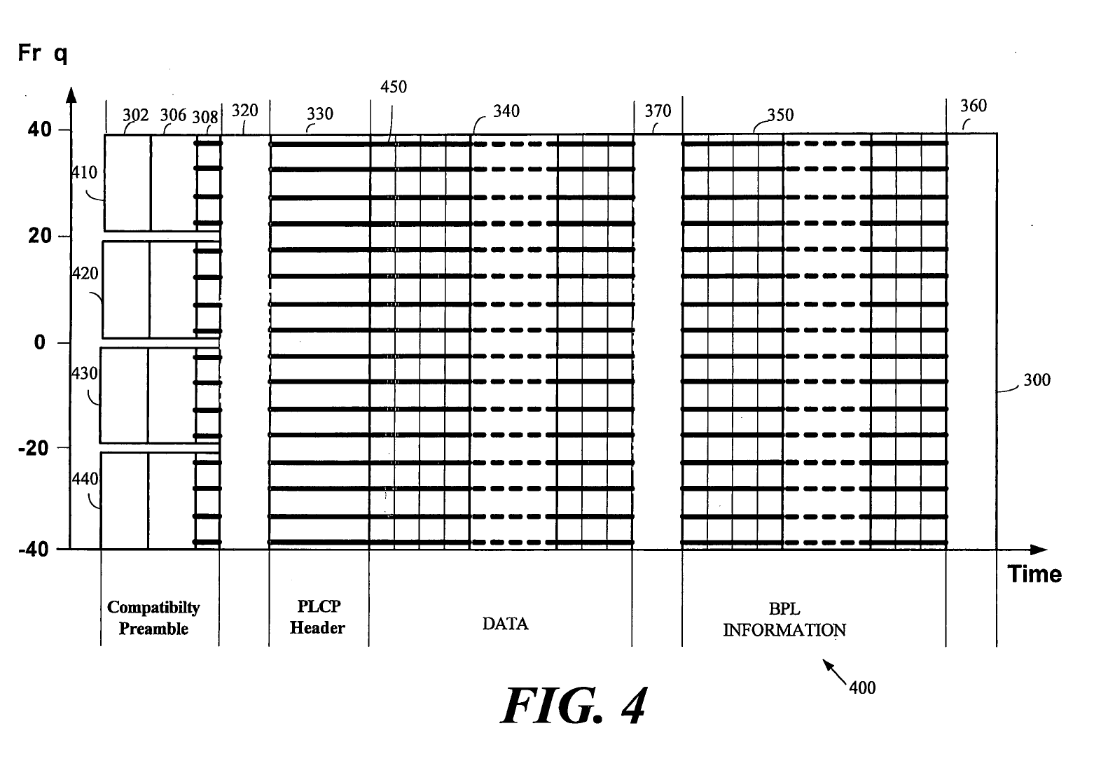

Although the scope of the present invention is not limited in this respect, data packet generator 220 may generate a data packet. An exemplary data packet structure is described in detail below with reference to FIGS. 3 and 4. In some embodiments of the invention encoder 230 may encode the data packet with encoding schemes such as, for example, a convolutional encoding scheme, a block encoding scheme, a Low-Density Parity Check (LDPC) encoding scheme, a Reed-Solomon encoding scheme, a turbo encoding scheme, or the like.

Although the scope of the present invention is not limited in this respect, modulator 240 may modulate the encoded data packet according to OFDM subcarrier modulation schemes such as, for example, binary phase shift keying (BPSK), quadrature phase shift keying (QPSK), quadrature-amplitude modulation (QAM) with different order such as, for example, QAM16, QAM32, QAM64, QAM128, QAM256, etc., differential BPSK (DBPSK), differential QPSK (DQPSK), or the like.

Although the scope of the present invention is not limited in this respect, receiver 260, for example, an OFDM receiver, may receive data packets from communication channel 140. Predictor 270 may predict long-term characteristics of communication channel 140 based on the information received from at least one of a prefix training field and a postfix training field of the received data packet, although the scope of the present invention is not limited in this respect. In some embodiments of the invention, the data packet may include a middle-fix training field, and predictor 270 may perform for long-term channel prediction by combining the information of the middle-fix training field with information from other fields of the data packet, if desired.

Turning to FIGS. 3 and 4. FIG. 3 is a schematic illustration of a structure of a data packet 300, for example, an OFDM data packet, according to an exemplary embodiment of the present invention, and FIG. 4 is a schematic illustration of an example of a time-frequency diagram of data packet 300 transmitted over an OFDM channel 400. Although the scope of the present invention is not limited in this respect, OFDM channel 400 may be a wideband channel and may include at least four 20 MHz sub-channels. In FIG. 3, data packet 300 may include training fields that may be used for long-term channel prediction, if desired. Data packet 300 may include a compatibility preamble field 310, a prefix training field 320, a PLCP header 330, which may include bit and power loading (BPL) information, data field 340, and postfix training field 360. In some embodiments of the invention data field 340 may be fragmented into two or more fragments, e.g., 342, 346, separated by at least one middle-fix training field 370.

Although the scope of the present invention is not limited in this respect, modulator 240 may provide similar and/or different modulation schemes to data fragments 342, 346. In some embodiments of the invention, modulator 240 may provide different modulation schemes to data fragments 342, 346. In some embodiments of the invention, encoder 230 may provide similar and/or different encoding schemes and/or rates to data fragments 342, 346. In some embodiments of the invention encoder 230 may provide different encoding schemes and/or encoding rates to data fragments 342, 346, if desired.

Although the scope of the present invention is not limited in this respect, FIG. 4 shows data packet 300 spread over wideband OFDM channel 400. For example, compatibility preamble field 310 may be spread over sub channels 410, 420, 430, 440. In addition, channel 400 may include sub-carriers 450, which are illustrated by thick horizontal lines.

Although the scope of the present invention is not limited in this respect, compatibility preamble field 310, and the prefix, postfix and middle-fix training fields (e.g. fields 320 360 and 370, respectively), may be used to perform tasks such as, for example, signal detection, channel estimation, timing synchronization, coarse and/or fine frequency offset estimation, channel transfer function estimation, channel variation estimation, long term channel prediction, and the like. In addition, compatibility preamble field 310 may carry plurality of logical functions such as, for example, packet type detection, support of compatibility with legacy devices, possibility of frequency division multiple access (FDMA) mode usage and the like.

Although the scope of the present invention is not limited in this respect, prefix, postfix and middle-fix training fields (e.g. fields 320 360 and 370, respectively) may be used for long term channel prediction, which may include, for example, prediction of channel variation during a delay in transmitting an estimate of channel state information (CSI). For example, a linear prediction method based on autoregressive (AR) modeling of the channel transfer function coefficients may be used for long-range prediction. In this method, the future channel transfer function coefficients may be predicted with minimum mean square error (MMSE) on the base on a number of previous estimates of the channel transfer function.

Although the scope of the present invention is not limited in this respect, compatibility preamble 310 may be constructed, for example, from 1, 2, 3 or 4 PLCP preambles, which may be transmitted in one, two, three or four 20 MHz sub-channels. The construction of at least one PLCP preamble within compatibility preamble field 310 may be done, for example, according to IEEE 802.11a standard, if desired. In some embodiments of the invention, compatibility preamble field 310 may be divided into a short combined preamble 302, a long combined preamble 306, and a combined signal field 308. In some embodiments of the invention, compatibility preamble field 310 may be used, for example, for energy detection, a packet type detection, a preliminary channel estimation, a timing synchronization, a frequency offset estimation and the like.

Although the scope of the present invention is not limited in this respect, short combined preamble 302 may include for example, 1, 2, 3 or 4 short preambles (e.g. as defined by IEEE-802.11a standard) that may be transmitted in one, two, three or four neighboring 20 MHz sub-channels. For example, sub channels 410, 420, 430, 440 may be transmitted substantially simultaneously, if desired. In some embodiments of the invention, channel 400 may be 80 MHz wide and may be divided into one, two, three or four sub channels of 20 MHz, if desired. For example, sub channel 410 may be from 40 MHz to 20 MHz, sub channel 420 may be from 20 MHz to 0 Hz, sub channel 430 may be from 0 Hz to −20 MHz and sub channel 440 may be from −20 MHz to −40 MHz, as is shown in FIG. 4.

In some embodiments of the invention, short preamble 302 of sub-channel 410 or short preamble 302 of sub-channel 440 may be rotated by 180 degrees relative to other sub-channels (e.g. sub channels 420, 430) to reduce Peak-to-Average Power Ratio (PAPR), if desired.

Although the scope of the present invention is not limited in this respect, long combined preamble 304 may include for example, 1, 2, 3 or 4 long preambles as defined by IEEE-802.11a standard, that may be transmitted in one, two, three or four neighboring 20 MHz sub-channels simultaneously, for example, sub channels 410, 420, 430, 440, respectively. Long preamble 306 of sub channel 410 or long preamble 306 of sub channel 440 may be rotated by 180 degrees relative to other sub-channels (e.g. sub channels 420, 430) to reduce the PAPR, if desired.

Although the scope of the present invention is not limited in this respect, combined signal field 308 may include, for example, 1, 2, 3 or 4 signal fields, as defined by IEEE-802.11a standard, which may be replicated in one, two, three or four neighboring 20 MHz sub-channels. In some embodiments, signal field 308 in sub-channels 410, 420, 430, 440 may include information that may be used to force other stations to enter the receiving state for the duration of the transmitted packet. This forced operation may protect the data transmission from unwanted interferences from those stations. Signal field 308 of sub channel 410 or signal field 308 of sub channel 440 may be rotated by 180 degrees relative to other sub-channels (e.g. sub channels 420, 430) to reduce the PAPR, if desired.

Although the scope of the present invention is not limited in this respect, it should be understood that in some embodiments of the invention, short preambles 302 and/or long preambles 306 and/or signal fields 308 transmitted on sub-channels 410, 420, 430, 440 may be rotated by any desired angle to reduce the PAPR, if desired.

Although the scope of the present invention is not limited in this respect, the prefix, postfix and middle-fix training fields, e.g., fields 320 360 and 370, respectively, may have, in some embodiments of the invention, substantially the same format. In some embodiments of the present invention, the prefix, postfix and middle-fix training fields, e.g., fields 320 360 and 370, respectively, may be constructed in accordance with the recommendations of IEEE 802.16 Broadband Wireless Access Working Group, available at http://ieee802.org/16, if desired. However, is some other embodiments of the present invention, other types of preambles may be used, if desired.

Although the scope of the present invention is not limited in this respect, prefix training field 320 may be used for wideband (WB) channel estimation, refinement of timing synchronization and frequency offset estimations at the beginning of the packet, and the like. The middle-fix (e.g., 370) and Postfix (e.g., 360) training fields may be provided for channel variation estimation at the middle and the end of the packet, respectively, to allow adaptive fragmentation capability, if desired. In some embodiments of the invention, data packet 300 may be fragmented into two or more fragments separated by middle-fix training field(s) 370. For example, a fragment of data packet 300 may have BPL information parameters, which may be calculated taking into account long-term channel prediction techniques. The long-term channel prediction techniques may increase overall throughput performance of the system by using longer packets. In some embodiments of the present invention the long-term prediction may be performed to increase the system throughput.

In some embodiments of the invention, further improved reliability of data packet transmission may be achieved by considering channel variation during bit and power loading calculations and by applying different bit and power loading parameters to the different fragments of data packet 300, if desired. In addition, prefix training field 320 and/or postfix training field 360 may be used to analyze failure of cyclic redundancy check (CRC), which failure may be caused by errors in a fragment of a received data packet that may result in loss of the fragment. In some cases, such as, for example, fragment loss may be caused by noise, by Dopller shift, or the like.

In some other embodiments of the invention, additional training fields may be incorporated in the middle of the packet, e.g. middle-fix training field 370. For example, middle-fix training field 370, may be included after at least one predetermined time interval, for example, 1 millisecond (ms) if the packet is longer than a channel coherence time, which may be, for example, 1.2 ms, if desired.

Although the scope of the present invention is not limited in this respect, PLCP header 330 may be used both as a collection of parameters needed to demodulate data packet 300 and/or as an additional training field, if desired. In exemplary embodiments of the invention, the spectrum width of channel 400 may be 80 MHz and PLCP header may include up to 4 OFDM symbols. As an example, the information in PLCP header 330 may be encoded by encoder 230 with the a convolutional code with a rate of ½ and may be modulated by modulator 240 with a desired modulation scheme such as, for example, binary phase shift keying (BPSK) or quadrature phase shift keying (QPSK) modulation, or the like. In addition, the PLCP header 330 that may be used as additional training field may allow a receiver to perform additional training such as, for example, frequency and phase estimation refinement, channel estimation refinement, and the like.

Although the scope of the present invention is not limited in this respect, PLCP header 330 may include the flowing parameters that may be used with WB OFDM WLAN systems. The first parameter may be a BPL information parameter 335, which may include a modulation types bit to indicate the modulation types per sub-carrier 450 and a power loading bit to indicate the power loading of sub-carriers 450. In some embodiments, sub-carriers 450 may be grouped into groups with similar modulation types.

Although the scope of the present invention is not limited in this respect, the second parameter may be an Overall Transmitted Power Level (e.g. 4 bits) parameter. This parameter may reflect the power level that may be used during transmission of data packet 300. The power level may be defined, for example, in 3 dB increments down from a maximal value of transmission power level, if desired. This parameter in conjunction with the “Available Tx Power Level” and “Power Request” parameters described below may be used in solving the Near-Far problem known to persons skilled in the art.

Although the scope of the present invention is not limited in this respect, an Available Tx Power Level parameter (e.g. 4 bits) may reflect the maximum transmitter power and may be defined in, for example, 3 dB increments. In some other embodiments of the invention, this parameter may be used in a network interface card (NIC), e.g., in a “save power” mode. A packet Duration parameter (e.g., 2 bytes) may reflect the duration of a current packet, e.g., in microseconds (μs), or using OFDM symbols, or any other suitable time-related units.

Although the scope of the present invention is not limited in this respect, other parameters may include a Packet Length parameter (e.g. 2 bytes) that may describe the length of a current packet in octets, a Quality of Receiving parameter (e.g. 2 bits) that may be transmitted in a response to a received transmission and may include, for example, four possible values, namely: “Packet Lost” (CRC failed), “Poor” (a relatively large number of errors have been recovered by error correction schemes), “good ” (a relatively small number of errors have been recovered by error correction schemes) and “excellent” (substantially no errors). In addition, a BPL Request parameter (e.g. 2 bits) may be used to request the BPL to be applied during a response transmission. For example, the BPL Request parameter may have values such as, for example, “Transmit robust”, “Use BPL same as in this packet”, “Use BPL same as for previous transmission”, “See MPDU for BPL information”.

Although the scope of the present invention is not limited in this respect, a BPL mode parameter (e.g. 1 bit) may select between normal and simplified modes of BPL information exchange, a Power Request parameter (e.g. 4 bits) may request that power level be applied during a response transmission and a Duration Recommendation parameter (e.g. 6 bits) may indicate a recommended duration of the packet in some predetermined units, for example, 200 μs to be applied during a response transmission. In addition, one or more of a CRC parameter (e.g. 1 byte), a Service field parameter (e.g. 1 byte), which may include a scrambler initialization and a Signal Tail parameter (e.g. 6 bits) that may be used for convolutional encoding and/or decoding, may also be implemented into the data packet 300 structure.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus comprising:
a data packet generator to generate a data packet including at least one of a compatibility preamble field, two or more training fields and a physical layer convergence protocol header that includes bit and power loading information, and wherein at least some of the compatibility preamble field, the two or more training fields and the physical layer convergence protocol header are encoded with a predetermined code and modulated by a predetermined modulation scheme.

2. The apparatus of claim 1, wherein the compatibility preamble field is subdivided in time into a short combined preamble, a long combined preamble and a combined signal field.

3. The apparatus of claim 2 wherein the short combined preamble comprises:
two or more short preambles transmitted over two or more sub-channels,
wherein one of the two or more short preambles is phase rotated relative to other short preambles in other sub-channels.

4. The apparatus of claim 2 wherein the long combined preamble comprises:
two or more long-preambles transmitted-over two or more sub-channels,
wherein one of the two or more long preambles is phase rotated relative to other long preambles in other sub-channels.

5. The apparatus of claim 2 wherein the combined signal field comprises:
two or more signal fields transmitted over two or more sub-channels, wherein one of the two or more signal fields is phase rotated relative to other signal fields in other sub-carriers.

6. The apparatus of claim 1, wherein the two or more training fields comprise:
a prefix training field and a postfix training field, both fields having substantially the same format, transmitted over two or more sub-channels of a channel.

7. The apparatus of claim 1, wherein the data packet comprises at least one data field fragmented into two or more fragments separated by at least one middle-fix training field.

8. The apparatus of claim 6, wherein the two or more training fields comprises:
a middle-fix training field having substantially the same format as the prefix training field and the postfix training field.

9. The apparatus of claim 7, comprising:
a modulator to modulate the two or more fragments using two or more modulation schemes, respectively.

10. The apparatus of claim 9, wherein the modulator is able to modulate a first fragment of the two or more fragments using a first modulation scheme and a second fragment of the two or more fragments using a second modulation scheme.

11. The apparatus of claim 9 comprising:
an encoder to encode a first fragment of the two or more fragments by a first code and a second fragment of the two or more fragments by a second code.

12. The apparatus of claim 1 comprising:
a predictor to predict long-term characteristics of a communication channel based on information received from at least one of the two or more training fields.

13. A method comprising:
generating a data packet including two or more fields selected from at least one of a compatibility preamble field and two or more training fields, wherein at least some of the compatibility preamble field and two or more training fields are encoded with a predetermined code and modulated by a predetermined modulation scheme.

14. The method of claim 13, comprising:
dividing two or more long preambles of a long combined preamble of a compatibility preamble field into two or more sub-channels; and
rotating a phase of one of the long preambles in one of the sub- channels.

15. The method of claim 14, comprising:
dividing two or more long preambles of the long combined preamble of the compatibility preamble field into two or more sub-channels; and
rotating a phase of one of the long preambles in one of the sub- channels.

16. The method of claim 14, comprising:
dividing two or more signal fields of a combined signal field of the compatibility preamble field into two or more sub-channels; and
rotating a phase of one of the signal fields in one of the sub-channels.

17. The method of claim 13, wherein generating comprises:
fragmenting a data field of the data packet into at least first and second fragments; and
separating the first and second fragments by a training field of two or more training fields.

18. The method of claim 17 comprising:
modulating first and second sub-carriers of the first and second fragments with first and second modulation schemes, respectively.

19. The method of claim 17 comprising:
encoding the first and second fragments by first and second encoding schemes, respectively.

20. The method of claim 17 comprising:
predicting long-term characteristics of a communication channel based on information received from at least one of the two or more training fields.

21. A wireless communication device comprising:
a data packet generator to generate a data packet including at least one of a compatibility preamble field, two or more training fields and a physical layer convergence protocol header that includes bit and power loading information, and wherein at least some of the compatibility preamble field, the two or more training fields and the physical layer convergence protocol header are encoded with a predetermined code and modulated by a predetermined modulation scheme; and
a dipole antenna to receive and transmit the data packet.

22. The wireless communication device of claim 21, wherein the compatibility preamble field is subdivided in time into a short combined preamble, a long combined preamble and a combined signal field.

23. The wireless communication device of claim 22 wherein the short combined preamble comprises:
two or more short preambles subdivided into two or more sub-channels,
wherein and one of the two or more short preambles is phase rotated relative to other short preambles in other sub-channels.

24. The wireless communication device of claim 22 wherein the long combined preamble comprises:
two or more long preambles subdivided into two or more sub-channels,
wherein one of the two or more long preambles is phase rotated relative to other long preambles in other sub-channels.

25. The wireless communication device of claim 22 wherein the combined signal field comprises:
two or more signal fields wherein, at least one signal field is subdivided into two or more sub-channels and one of the two or more short preambles is phase rotated relative to other short preambles in other sub-channels.

26. The wireless communication device of claim 21, wherein the two or more training fields comprise:
a prefix training field and a postfix training field, both fields having substantially the same format, transmitted over two or more sub-channels of a channel.

27. The wireless communication device of claim 21, wherein the data packet comprises at least one data field fragmented into two or more fragments separated by at least one middle-fix training field.

28. The wireless communication device of claim 26, wherein the two or more training fields comprises:
a middle-fix training field having substantially the same format as the prefix training field and the postfix training field.

29. The wireless communication device of claim 27, comprising:
a modulator to modulate the two or more fragments using two or more modulation schemes, respectively.

30. The wireless communication device of claim 29, wherein the modulator is able to modulate a first fragment of the two or more fragments using a first modulation scheme and a second fragment of the two or more fragments using a second modulation scheme.

31. The wireless communication device of claim 29 comprising:
an encoder to encode a first fragment of the two or more fragments by a first code and a second fragment of the two or more fragments by a second code.

32. A wireless communication system comprising:
two or more wireless communication devices wherein at least one of the two or more communication devices include:
a data packet generator to generate a data packet including at least one of a compatibility preamble field, two or more training fields and a physical layer convergence protocol header that includes bit and power loading information, and wherein at least some of the compatibility preamble field, the two or more training fields and the physical layer convergence protocol header are encoded with a predetermined code and modulated by a predetermined modulation scheme.

33. The wireless communication system of claim 32, wherein the compatibility preamble field is subdivided in time into a short combined preamble, a long combined preamble and a combined signal field.

34. The wireless communication system of claim 33 wherein the short combined preamble comprises:
two or more short preambles subdivided into two or more sub-channels,
wherein and one of the two or more short preambles is phase rotated relative to other short preambles in other sub-channels.

35. The wireless communication system of claim 33 wherein the long combined preamble comprises:
two or more long preambles subdivided into two or more sub-channels,
wherein one of the two or more long preambles is phase rotated relative to other long preambles in other sub-channels.

36. The wireless communication system of claim 33 wherein the combined signal field comprises:
two or more sub-channels and one of the two or more short preambles is phase rotated relative to other short preambles in other sub-channels.

37. The wireless communication system of claim 32, wherein the two or more training fields comprise:
a prefix training field and a postfix training field, both fields having substantially the same format, transmitted over two or more sub-channels of a channel.

38. The wireless communication system of claim 32, wherein the data packet comprises at least one data field fragmented into two or more fragments separated by at least one middle-fix training field.

39. The wireless communication system of claim 36, wherein the two or more training fields comprises:
a middle-fix training field having substantially the same format as the prefix training field and the postfix training field.

40. The wireless communication system of claim 39, comprising:
a modulator to modulate the two or more fragments using two or more modulation schemes, respectively.

41. The wireless communication system of claim 40, wherein the modulator is able to modulate a first fragment of the two or more fragments using a first modulation scheme and a second fragment of the two or more fragments using a second modulation scheme.

42. The wireless communication system of claim 40 comprising: an encoder to encode a first fragment of the two or more fragments by a first code and a second fragment of the two or more fragments by a second code.
